(19) United States
(12) Patent Application Publication
(10) Pub. No.: US 2006/0225765 A1
(43) Pub. Date: Oct. 12, 2006

(54) Impregnating dental floss with hydrogen peroxide

(76) Inventor: Sandra Mary Moore, Grass Valley, CA (US)

Correspondence Address: MICHAEL RIES, 1747A VERMONT DRIVE, ELK GROVE, IL, 60007, US

(21) Appl. No.: 11/103,279

(22) Filed: Apr. 11, 2005

(51) Int. Cl. A61C 15/00

(52) U.S. Cl. 132/321

(57) ABSTRACT

Impregnated dental floss with hydrogen peroxide is disclosed which when delivered locally substantially lowers staining between the teeth. The non toxic and antiseptic properties of H₂O₂ reach under the gum line and the bleaching action help stains between the teeth.

### TECHNICAL FIELD & BACKGROUND

The present invention generally relates to the field of impregnating dental floss with hydrogen peroxide. More specifically, the present invention relates to non toxic and antiseptic properties of hydrogen peroxide or H₂O₂ that would reach under the gum line, and second, the bleaching action would help substantially lower stains between teeth.

There is a constant search to improve dental hygiene. Similar products on the market today use elaborate methods or devices to improve dental hygiene. The present invention delivers substantially lower staining between teeth by impregnating dental floss with hydrogen peroxide. The non toxic and antiseptic properties of H₂O₂ would reach under the gum line and the bleaching action would help reduce stains between the teeth.

### DETAILED DESCRIPTION

Various aspects will be described using terms commonly employed by those skilled in the art to convey the substance of their work to others skilled in the art. However, it will be apparent to those skilled in the art that the present invention may be practiced with only some of the described aspects.

Dental floss is impregnated with hydrogen peroxide to substantially lower staining between teeth. The non toxic and antiseptic properties of H₂O₂ reach under the gum line and the bleaching action helps reduce stains between teeth. Impregnating will cause the dental floss to be filled, soaked, or saturated with H₂O₂. H₂O₂ is administered between the teeth using a delivery system having H₂O₂ impregnated dental floss. Both the benefits of reducing stains between the teeth and effects of dental flossing are provided at the same time.

Frequent use of dental floss is needed to maintain oral hygiene and avoid periodontal disease. Impregnating dental floss with H₂O₂ will cause the activity of flossing ones teeth to perform two functions at the same time. Impregnated dental floss will reduce stains between the teeth while at the same time perform the dental benefits of the physical contact with the teeth. The H₂O₂ will be maintained on the dental floss with a pharmaceutically acceptable carrier that can be used in a person's mouth. The H₂O₂ may be disbursed on the surface of the dental floss. The H₂O₂ may be disbursed into the body of the dental floss. The H₂O₂ will subsequently be released from the dental floss as a local and the non toxic and antiseptic properties of H₂O₂ will reach under the gum line and the bleaching action will reduce stains between teeth.

H₂O₂ is mixed with an orally acceptable carrier to form a H₂O₂ mixture. The mixture is stirred to substantially uniformly disperse the H₂O₂ throughout the mixture. Orally acceptable carriers may be any one or combination comprising water, alcohols such as ethanol, propylene glycol, waxes such as polyethylene glycol and glycerol, and sugar solutions or any other suitable carrier for inside a human mouth. The carrier may substantially slow the evaporation rate of H₂O₂ The carrier may stop any evaporation of H₂O₂.

The terms “comprising”, “having” and “including” are synonymous, unless the context dictates otherwise.

What is claimed is:

1. A device comprising:
A device comprising:
a dental floss having a substantially uniform amount of hydrogen peroxide dispersed thereon, wherein the hydrogen peroxide substantially reduces stains between teeth.

2. The device of claim 1, wherein the dental floss is multi-stranded.

3. The device of claim 1, wherein the dental floss is saturated with hydrogen peroxide.

4. The device of claim 1, wherein the H₂O₂ is delivered locally.

5. The device of claim 1, wherein the H₂O₂ has a carrier that slows the evaporation rate of H₂O₂.

6. A method comprising:
providing hydrogen peroxide; and
applying the hydrogen peroxide to dental floss.

7. The method of claim 6, wherein the hydrogen peroxide is uniformly dispersed on the dental floss.

8. The method of claim 6, wherein the hydrogen peroxide reaches under the gum line and produces a bleaching action that substantially reduces stains between the teeth.

9. The method of claim 6, comprising reducing substantially stains between the teeth.

10. The method of claim 6, wherein the hydrogen peroxide H₂O₂ is delivered locally.

11. The method of claim 6, wherein the hydrogen peroxide has a carrier that slows the evaporation rate of H₂O₂

12. The method of claim 6, wherein a substantially uniformly dispersed amount of hydrogen peroxide is impregnating that will cause the dental floss to be filled, socked, or saturated with H₂O₂.

13. A method comprising:
providing dental floss; and
flossing teeth with the dental floss having hydrogen peroxide.

14. The method of claim 13, wherein the hydrogen peroxide is uniformly dispersed on the dental floss.

15. The method of claim 13, wherein the hydrogen peroxide reaches under the gum line and produces a bleaching action that substantially reduces stains between the teeth at the same time that the flossing motion improves overall oral hygiene by reducing periodontal disease.

16. The method of claim 13, comprising reducing substantially stains between the teeth.

17. The method of claim 13, wherein the hydrogen peroxide is uniformly dispersed on the dental floss and the uniformly dispersed amount of hydrogen peroxide is impregnating that will cause the dental floss to be filled, soaked, or saturated with H₂O₂.

18. The method of claim 13, wherein the hydrogen peroxide H₂O₂ is delivered locally.

19. The method of claim 13, wherein the hydrogen peroxide has a carrier that slows the evaporation rate of H₂O₂
